(19) United States
(12) Patent Application Publication
(10) Pub. No.: US 2010/0220589 A1
(43) Pub. Date: Sep. 2, 2010

(54) METHOD, APPARATUS, AND SYSTEM FOR PROCESSING BUFFERED DATA

(75) Inventors: Qin Zheng, Shenzhen (CN); Haiyan Luo, Shenzhen (CN); Yunfeng Bian, Shenzhen (CN); Hui Lu, Shenzhen (CN)

Correspondence Address: Docket Clerk/HTCL, P.O. Drawer 800889, Dallas, TX, 75380, US

(73) Assignee: Huawei Technologies Co., Ltd.

(21) Appl. No.: 12/779,745

(22) Filed: May 13, 2010

Related U.S. Application Data
(63) Continuation of application No. PCT/CN2009/070224, filed on Jan. 20, 2009.

(30) Foreign Application Priority Data
Feb. 4, 2008 (CN) 200810057696.6

(51) Int. Cl. H04L 12/24

(52) U.S. Cl. 370/230

(57) ABSTRACT

A method, an apparatus, and a system for processing buffered data are disclosed. The method includes: packing data packets in a same queue; splitting the packed data packet into multiple data cells according to a predetermined cell size; and storing the split data cells in multiple memories. The preceding method, apparatus, and system improve the read and write efficiency of the memories and improve the balance of the read and write bandwidths among multiple memories, thus improving the system performance.

### CROSS-REFERENCE TO RELATED APPLICATIONS

This application is a continuation of International Application No. PCT/CN2009/070224, filed on Jan. 20, 2009, which claims priority to Chinese Patent Application No. 200810057696.6, filed on Feb. 4, 2008, both of which are hereby incorporated by reference in their entireties.

### TECHNICAL FIELD

The present invention relates to a communication technology, and in particular, to a method, an apparatus, and a system for processing buffered data.

### BACKGROUND

Packet buffering is a critical technology for the modern communication equipment. It buffers data packets in case of traffic congestion, thus avoiding or reducing the traffic loss. As the port rate increases, the high-end communication equipment generally adopts a parallel packet buffering technology to obtain a packet buffer bandwidth matching the port rate. FIG. 1 shows a structure of a system for processing buffered data in the prior art. The system is composed of N parallel memories. Data packets entering from a port pass through an enqueue controller and are distributed by a storage controller to each memory for buffering. The packet control information enters a packet queue. A dequeue controller schedules the packet control information from the packet queue, reads the packet data from a memory through the storage controller, and sends the packet data to the downstream equipment. In FIG. 1, A indicates a data channel, and B indicates a control channel.

Because the dequeue controller can read only the packet data from a memory selected by the enqueue controller, the dequeue controller may schedule the packets from the same memory within a certain period of time, causing the dequeue bandwidth of the packet buffer to be only one N^{th} of the rated capacity. Thus, the preceding system for buffering multiple parallel packets needs to balance the write and read bandwidths among multiple memories.

Currently, the following methods are used to balance the read and write bandwidths among multiple memories: (1) Storing the packets to multiple parallel memories in small cells. That is, each packet is split according to the smallest cell (for example, 32 bits) of each memory and stored in multiple memories. In this way, each packet is read from multiple memories in case of dequeue, thus reducing the degree of imbalance of the dequeue bandwidth. (2) Dequeuing multiple packets. That is, multiple packets are allowed to be scheduled from a queue at a time. The packets in the same queue are stored in multiple memories in sequence when they are enqueued. In this way, the packet data may be evenly distributed in multiple memories, thus improving the balance of the read bandwidth among multiple memories when they are dequeued.

By using the first method, for a general dynamic random-access memory (DRAM), small cell storage may reduce the read and write efficiency of each memory, thus reducing the effective bandwidth of the entire packet buffer. By using the second method, it is complex to schedule multiple packets from a queue. In addition, when a larger storage cell is used to increase the valid bandwidth of each memory, the space efficiency and bandwidth efficiency of each memory may be greatly reduced. In case of enqueue, the packets need to be stored in each memory in sequence, which may also cause the imbalance of the write bandwidth among multiple memories.

### SUMMARY

Embodiments of the present invention provide a method, an apparatus, and a system for processing buffered data to increase the read and write efficiency of the memory and improve the balance of the write and read bandwidths among multiple memories, thus improving the system performance.

A method for processing buffered data includes:

packing multiple data packets in a queue;

splitting the packed data packet into multiple data cells according to a predetermined cell size; and

storing the data cells in multiple memories.

The preceding method increases the write and read efficiency of the memories and improves the balance of the write and read bandwidths among multiple memories, thus improving the system performance.

An apparatus for processing buffered data includes:

a packing module, configured to pack data packets in a queue;

a splitting module, configured to split the packed data packet into multiple data cells according to a predetermined cell size; and

a storing module, configured to store the data cells in multiple memories.

The preceding apparatus increases the write and read efficiency of the memories and improves the balance of the write and read bandwidths among multiple memories.

A system for processing buffered data includes:

an enqueue controller, configured to pack data packets in a queue;

a storage controller, configured to: split the packed data packet into multiple data cells according to a predetermined cell size and control the distribution of split data cells; and

multiple parallel memories, configured to: store the data cells, where the split data cells are stored in multiple memories.

The preceding system increases the write and read efficiency of the memories and improves the balance of the write and read bandwidths among multiple memories, thus improving the system performance.

The present invention is hereinafter described in detail with reference to embodiments and accompanying drawings.

### BRIEF DESCRIPTION OF THE DRAWINGS

FIG. 1 shows a structure of a system for processing buffered data in the prior art;

FIG. 2 is a flowchart of a method for processing buffered data in an embodiment of the present invention;

FIG. 3 shows a structure of an apparatus for processing buffered data in an embodiment of the present invention; and

FIG. 4 shows a structure of a system for processing buffered data in an embodiment of the present invention.

### DETAILED DESCRIPTION

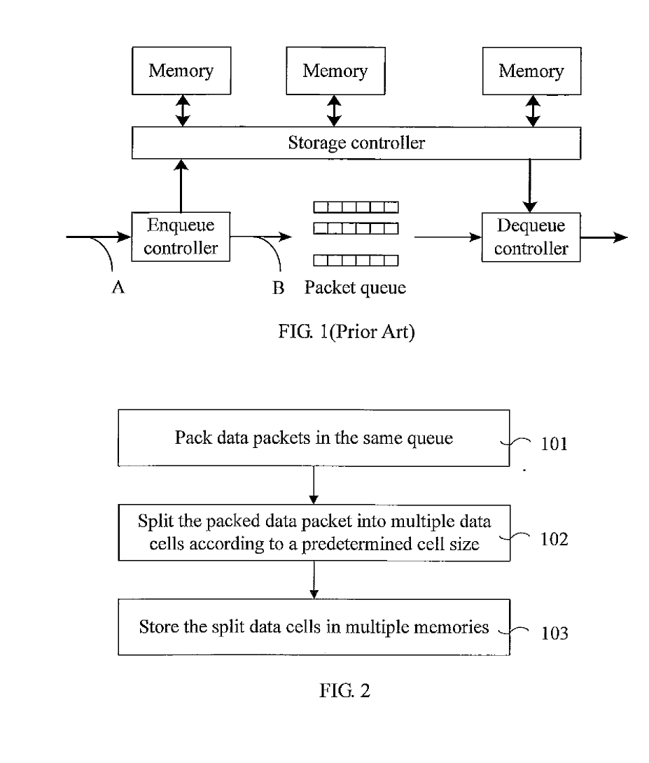

FIG. 2 is a flowchart of a method for processing buffered data in an embodiment of the present invention. The method includes:

Step 101: Pack the data packets in the same queue.

The data packets entering the same queue are packed according to a predetermined length. A status entry is set for the data in the same queue. The status entry is used for maintaining each queue in which the packets are packed, and recording the length of each packet being packed. When the packed packet length of a queue reaches the predetermined length, a packed data packet is formed. The predetermined length is set according to conditions such as the quantity of memories. In addition, when the length of the packet formed by packing the last packet in the same queue and the incoming data packet exceeds the predetermined length, the packet packing is completed.

Step 102: Split the packed data packet into multiple data cells according to the predetermined cell size.

The packed data packet is split according to a predetermined cell size. The predetermined cell size may be determined according to the actual requirement. For example, it may be determined according to the packet size and the quantity of memories.

Step 103: Store the split data cells in multiple memories.

Before the split data cells are stored in multiple memories, the method may further include: comparing the lengths of write request queues in each memory, and selecting the memory with the shortest write queue length as the first memory for storing the split data cells. The shorter the length of write request queues in a memory, the lower the traffic written to the memory. Selecting the memory with the shortest write request queue may effectively balance the write and read bandwidths among multiple memories. In addition, for fast and easy reading from memories, the split data cells maybe evenly stored at the same address in multiple memories or multiple continuum memories starting from the first memory.

In addition, a read process may be included after step 103. That is, reading data from a memory storing the read data that needs to be read according to a read request. If the read data that needs to be read by the read request is stored in multiple continuum memories starting from the first memory, the data also needs to be read from the multiple continuum memories.

Further, when the predetermined length is not the size of an integer number multiple of the predetermined cell, the dequeue operation may cause certain imbalance of the read bandwidth among multiple memories. To balance the read bandwidth, when the data that needs to be read by the read request sent to a memory exceeds the read bandwidth of the memory, the data may be stored in an on-chip buffer.

According to the method for processing buffered data in an embodiment of the present invention, the data in the same queue is packed into a large packet, and the split data cells are stored in multiple memories. Therefore, the read and write efficiency of the memories is greatly increased; the read and write bandwidths are balanced among multiple memories; and the system performance is improved.

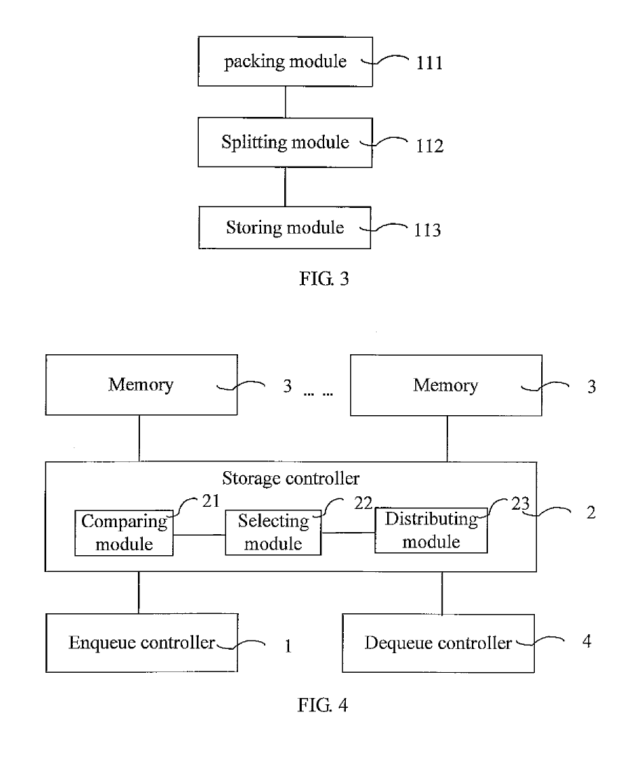

FIG. 3 shows a structure of an apparatus for processing buffered data in an embodiment of the present invention. The apparatus includes: a packing module 111, configured to pack data packets in the same queue; a splitting module 112, configured to split the packed data packet into multiple data cells according to the predetermined cell size; and a storing module 113, configured to store the split data cells in multiple memories.

In addition, the preceding apparatus may further include: a selecting module, configured to: compare lengths of write request queues in each memory, and select a memory with the shortest write queue length as the first memory for storing the split data cells; or a reading module, configured to read data from the storing module according to a read request. The preceding storing module may be an even storing module, and is configured to evenly store the split data cells at the same address in multiple memories. The even storing module may be an even continuum storing module, and is configured to evenly store the split data cells at the same address in multiple continuum memories starting from the first memory. The preceding reading module may be a continuum reading module, and is configured to read data from multiple continuum memories starting from the first memory according to the read request.

According to the preceding apparatus for processing buffered data, the packing module is used to pack data packets in the same queue into a large packet; the splitting module is used to split the packet into data cells; the storing module is used to store the split data cells in multiple memories or the even storing module is used to evenly store the data cells at the same address in each memory. In addition, the reading module may be used to read data from the storing module storing the data cells. Thus, the read and write efficiency of memories is increased, and the read and write bandwidths are balanced among multiple memories.

FIG. 4 shows a structure of a system for processing buffered data in an embodiment of the present invention. The system includes: an enqueue controller 1, configured to pack the data packets in the same queue; a storage controller 2, configured to split the packed data packet into multiple data cells according to the predetermined cell size and control the distribution of split data cells; multiple parallel memories 3, configured to store split data cells, where the data cells are stored in multiple memories.

The split packets are stored in memories in cells with a fixed length. The cell length may be as large as possible to ensure the read and write efficiency of each memory 3. Taking a 32-bit-wide DRAM as an example, the cell length may be set to 512 bits. Each cell is stored in the same bank of the DRAM to avoid the impact on the read and write efficiency due to the time sequence restriction of bank switching. In case of enqueue, all cells except the first cell cannot freely select memories for writing. To improve the imbalance of the Write bandwidth among multiple memories, the preceding storage controller 2 includes: a comparing module 21, configured to compare the lengths of write request queues in each memory; a selecting module 22, configured to select a memory with the shortest write request queue as the first memory for storing the split data cells; and a distributing module 23, configured to distribute the preceding split data cells to memories starting from the first memory.

In addition, to effectively improve the imbalance of the write bandwidths, each memory 3 includes: a first buffering module, configured to store data traffic exceeding the bandwidth when the data traffic sent by the enqueue controller to the memory for storage exceeds the write bandwidth of the memory. Further, the preceding embodiment may further include: a dequeue controller 4, configured to read data from the memory storing the read data that needs to be read according to the read request. The preceding storage controller may be a continuum storage controller, which is configured to: split the packed data packet into multiple data cells according to the predetermined cell size, and distribute the split data cells to multiple continuum memories starting from the first memory. The preceding dequeue controller may also be a continuum dequeue controller, which is configured to read data that needs to be read from multiple continuum memories starting from the first memory according to the read request. Because the split data cells are stored in multiple memories, the balance of the write bandwidths is guaranteed. In addition, because the dequeue controller can only read data packets from the memory selected by the enqueue controller, the balance of read bandwidths is guaranteed.

When the data that needs to be read according to the read request sent to the memory selected by the enqueue controller exceeds the read bandwidth of the memory, the imbalance of the read bandwidths may also be caused. To improve this situation, the preceding each memory further includes a second buffering module, which is configured to: store the data that needs to be read according to the read request, when the data that needs to be read according to the read request sent to the memory selected by the enqueue controller exceeds the read bandwidth of the memory.

In the preceding embodiment, the enqueue controller is used to pack the data in the same queue into a packet; the packed data packet is split into data cells according to the predetermined cell size, that is, the large cell, and multiple parallel memories are used to store the preceding data cells; the on-chip buffer is used to store the data that needs to be read according to the read request when the data exceeds the read bandwidth of the memory. Thus, the read and write efficiency of the memories is increased; the balance of the read and write bandwidths among multiple memories is improved; the system performance is improved.

It should be noted that the above embodiments are merely provided for elaborating the technical solutions of the present invention, but not intended to limit the present invention. Although the present invention has been described in detail with reference to the foregoing embodiments, it is apparent that those skilled in the art can make various modifications and variations to the invention without departing from the scope of the invention. The invention shall cover the modifications and variations provided that they fall in the scope of protection defined by the following claims or their equivalents.

What is claimed is:

1. A method for processing buffered data, the method comprising:
packing data packets in a queue into a packed data packet;
splitting the packed data packet into multiple split data cells according to a predetermined cell size; and
storing the split data cells in multiple memories.

2. The method of claim 1, wherein after storing the split data cells in multiple memories, the method further comprises: reading data from a memory storing read data that needs to be read according to a read request.

3. The method of claim 1, wherein packing the data packets in the queue into a packed data packet comprises:
packing the packets in the queue into the packed data packet according to a predetermined length.

4. The method of claim 1, wherein storing the split data cells in the multiple memories comprises:
storing the split data cells evenly at a same address in the multiple memories.

5. The method of claim 4, wherein the method further comprises:
comparing lengths of write request queues in the multiple memories, and selecting a memory with a shortest write request queue as a first memory for storing the split data cells;
wherein storing the split data cells evenly at the same address in the multiple memories comprises:
storing the split data cells evenly at the same address in multiple continuum memories starting from the first memory.

6. The method of claim 2, wherein the method further comprises:
comparing lengths of write request queues in the multiple memories, and selecting a memory with a shortest write request queue as a first memory for storing the split data cells;
wherein reading the data from the memory storing the read data that needs to be read according to the read request comprises: reading the data that needs to be read according to the read request from multiple continuum memories starting from the first memory.

7. The method of claim 2, further comprising: when the data that needs to be read according to the read request exceeds a read bandwidth of the memory, storing the data that needs to be read.

8. An apparatus for processing buffered data, the apparatus comprising:
a packing module, configured to pack data packets in a queue into a packed data packet;
a splitting module, configured to split the packed data packet into multiple split data cells according to a predetermined cell size; and
a storing module, configured to store the split data cells in multiple memories.

9. The apparatus of claim 8, further comprising:
a reading module, configured to read data from the storing module according to a read request.

10. The apparatus of claim 8, wherein the storing module is an even storing module configured to evenly store the split data cells at a same address in the multiple memories.

11. The apparatus of claim 10, further comprising:
a selecting module, configured to: compare lengths of write request queues in the multiple memories, and select a memory with a shortest write request queue as a first memory for storing the split data cells;
wherein the even storing module is an even continuum storing module configured to evenly store the split data cells at a same address in multiple continuum memories starting from the first memory.

12. The apparatus of claim 9, further comprising:
a selecting module, configured to: compare lengths of write request queues in the multiple memories, and select a memory with a shortest write request queue as a first memory for storing the split data cells;
wherein the reading module is a continuum reading module configured to read data that needs to be read according to the read request from multiple continuum memories starting from the first memory.

13. A system for processing buffered data, the system comprising:
an enqueue controller, configured to pack data packets in a queue into a packed data packet;
a storage controller, configured to: split the packed data packet into multiple split data cells according to a predetermined cell size and control distribution of the split data cells; and
multiple parallel memories, configured to store the split data cells, wherein the split data cells are stored in multiple memories.

14. The system of claim 13, wherein the storage controller comprises:
a comparing module, configured to compare lengths of write request queues in the multiple memories;
a selecting module, configured to select a memory with a shortest write request queue as a first memory for storing the split data cells; and
a distributing module, configured to distribute the split data cells to memories starting from the first memory.

15. The system of claim 13, further comprising:
a first buffering module, configured to: when data traffic that the enqueue controller sends to a memory exceeds a write bandwidth of the memory, store the data traffic.

16. The system of claim 14, further comprising:
a dequeue controller, configured to read data from a memory storing read data that needs to be read according to a read request.

17. The system of claim 14, wherein the storage controller is a continuum storage controller, configured to: split the packed data packet into multiple split data cells according to the predetermined cell size, and distribute the split data cells to multiple continuum memories starting from the first memory.

18. The system of claim 16, wherein the dequeue controller is a continuum dequeue controller, configured to read the data that needs to be read according to the read request from multiple continuum memories starting from the first memory.

19. The system of claim 13, further comprising:
a second buffering module, configured to: when the data that needs to be read according to the read request exceeds a read bandwidth of the memory, store the data that needs to be read.
